(19) United States
(12) Patent Application Publication
(10) Pub. No.: US 2012/0055361 A1
(43) Pub. Date: Mar. 8, 2012

(54) METHOD FOR MAKING PRINTING PLATE

(75) Inventor: Kiyohiko TAKEMOTO, Matsumoto-shi (JP)

(73) Assignee: SEIKO EPSON CORPORATION.

(21) Appl. No.: 13/198,955

(22) Filed: Aug. 5, 2011

(30) Foreign Application Priority Data
Sep. 2, 2010 (JP) 2010-196959

(51) Int. Cl. B41C 3/00

(52) U.S. Cl. 101/401.1

(57) ABSTRACT

A method for making a printing plate includes an operation that ejects an ink onto a printing original plate from an ink jet head. The ink contains water, a pigment, a resin, a first organic compound having a boiling point of 260° C. or more at 1 atmospheric pressure or a melting point of 90° C. or more at 1 atmospheric pressure, and a second organic compound having a boiling point in the range of 100 to 250° C. at 1 atmospheric pressure.

Priority is claimed under 35 U.S.C §119 to Japanese Application No. 2010-196959 filed on Sep. 2, 2010, which is hereby incorporated by reference in its entirety.

### BACKGROUND

1. Technical Field

The present invention relates to a method for making a printing plate.

2. Related Art

Offset printing is a printing technique that has been widely used for a long time, and is used for printing a moderate number of copies, such as in the range of about 1,000 to 15,000 copies. With the advent of computers, considerable efforts have been made for developing simple, inexpensive computer systems for offset printing plate making. In particular, there has been a strong demand for an economical and efficient computer system for making a printing plate used for producing small batches of a variety of products.

An ink jet printing system, which is one of the computer printing plate making systems, can reliably produce color images at low cost. Accordingly, many proposals have been made to apply an ink jet printing system to printing plate making methods and apparatuses.

For example, a method has been known for making a printing plate using an ink jet printing system, in which a master pattern is formed by ejecting an ink from an ink jet head onto a printing original plate coated with a photosensitive material, and then exposing the plate to light. In this method, printing plates are made using an ink jet printing system instead of using a photomask through which versatile plates are exposed to light. Accordingly, the process for making printing plates is complicated, and is inferior in terms of cost efficiency and environmentally disadvantageous.

Methods and apparatuses for making printing plates using an ink jet printing system are disclosed in, for example, Japanese Patent No. 3485934, and JP-A-2002-36491, JP-A-2004-66817, and JP-A-2004-130780.

A printing plate making method as disclosed in Japanese Patent No. 3485934 has been known as one of the approaches for overcoming the above disadvantages. In this method, a printing plate is made by forming a lipophilic pattern on a hydrophilic surface of a printing original plate by an ink jet printing system, and then exposing the pattern to an energy source, such as heat or UV light. In this method, however, the ink to be ejected from the ink jet head contains materials (monomers, oligomers, and polymers) for ensuring thermal curing or UV curing, and a highly reactive metal complex, from the viewpoint of making a highly durable printing plate. This makes it difficult to achieve stable ejection from the ink jet head, and causes deviation of ejected ink droplets or may result in nonuniformity or missing dots. Accordingly, a high-definition or high-resolution printing plate is difficult to make.

Other approaches for overcoming the above disadvantages have been disclosed in, for example, JP-A-2002-36491, JP-A-2004-66817, and JP-A-2004-130780. In these disclosures, printing plates are made by ejecting an ink mainly containing a melted solid or phase-changed wax or resin onto a printing original plate to form a pattern. In this method, however, the lipophilic layer of the pattern is formed into a mound, and the resulting printing plate may be inferior in durability.

### SUMMARY

Accordingly, an advantage of some aspects of the invention is that it provides a method for making a printing plate that allows an ink to be ejected stably, that is highly durable, and that is capable of high-resolution printing.

The present inventors have conducted intensive research to solve the above issue. As a result, the inventors have found that the above disadvantages can be overcome by a method including an operation that ejects an ink containing water, a pigment, a resin, an organic compound having a high boiling pint, and an organic compound having a medium boiling point in specific proportions onto a printing original plate from an ink jet head.

According to an aspect of the invention, the following method is provided for making a printing plate. The method includes an operation that ejects an ink onto a printing original plate from an ink jet head. The ink contains water, a pigment, a resin, a first organic compound having a boiling point of 260° C. or more at 1 atmospheric pressure or a melting point of 90° C. or more at 1 atmospheric pressure, and a second organic compound having a boiling point in the range of 100 to 250° C. at 1 atmospheric pressure. The ink satisfies the following expressions (1) to (3):

5% by mass<(C)<25% by mass (1);

{(C)+(D)}≧12% by mass (2); and

0.25≦{(A)+(B)}/{(C)+(D)}≦0.5 (3).

In the expressions, (A), (B), (C) and (D) represent the pigment content, the resin content, the first organic compound content, and the second organic compound content in the ink, respectively.

Preferably, the ink further satisfies the following expression (4):

{(C)/(D)}≧5 (4)

The method may further include the operation that heats the printing original plate on which the ink has been deposited.

### DESCRIPTION OF EXEMPLARY EMBODIMENTS

An embodiment of the invention will now be described in detail. The invention is not limited to the following embodiment, and various modifications may be made within the scope and spirit of the invention.

In the description hereinafter, “(meth)acrylate” refers to an acrylate and a corresponding methacrylate, and a (meth)acrylic compound refers to an acrylic or methacrylic compound.

The term “high boiling point” mentioned herein refers to a boiling point of 260° C. or more at 1 atmospheric pressure. For example, a boiling point of 260° C. at 1 atmospheric pressure (760 mmHg) is equivalent to a boiling point of 150° C. or more at 3.9×10⁻² atmospheric pressure (30 mmHg) and a boiling point of 110° C. or more at 6.6×10⁻³ atmospheric pressure (5 mmHg). The term “medium boiling point” mentioned herein refers to a boiling point in the range of 100 to 250° C. at 1 atmospheric pressure.

The term “durability” mentioned herein is a property representing the number of copies that a printing plate can prepare by offset printing. The transfer from the printing plate to a printing sheet or paper is performed by contact. A printing plate inferior in durability gradually wears out with continued usage. Accordingly, the clearness of high-resolution image patterns and small characters is reduced, and the printed images eventually become illegible. The term “ejection stability” refers to a characteristic that ink droplets can be constantly ejected stably without clogging nozzles. “Cost efficiency” refers to a property representing the amount of money the user will spend for the entire process from designing to printing, including plate making. “Environmental advantage” refers to the degree of energy spent in and the waste produced from the entire process from designing to printing, including plate making. “Adhesion” refers to the degree to which an ink (ink coating) adheres to the printing original plate. A “water-soluble” substance means that the substance has a solubility of 10 g or more in 100 g of water at 20° C.

### Method for Making Printing Plate

An embodiment of the invention relates to a method for making a printing plate. The method includes an operation in which a specific ink is ejected from an ink jet head onto a printing original plate.

The specific ink contains water, a pigment, a resin, a first organic compound having a boiling point of 260° C. or more at 1 atmospheric pressure or a melting point of 90° C. or more at 1 atmospheric pressure, and a second organic compound having a boiling point in the range of 100 to 250° C. at 1 atmospheric pressure. In addition, the constituents of the specific ink satisfy the following expressions (1), (2), and (3).

5% by mass<(C)<25% by mass (1)

{(C)+(D)}÷12% by mass (2)

0.25≦[{(A)+(B)}/{(C)+(D)}]≦0.5 (3)

In the expressions, (A), (B), (C) and (D) represent the pigment content, the resin content, the first organic compound content, and the second organic compound content in the ink, respectively.

If (C)≧25% by mass holds true, the content of the first organic compound (having a boiling point of 260° C. or more at 1 atmospheric pressure or a melting point of 90° C. or more at 1 atmospheric pressure) is too high to fix the ink to the plate by heating. In contrast, if (C)≦5% by mass holds true, the ink is likely to clog nozzles and cannot be stably ejected. If {(C)+(D)}<12% by mass holds true, at least either the content of the second organic compound (having a boiling point in the range of 100 to 250° C. at 1 atmospheric pressure) or the content of the first organic compound (having a boiling point of 260° C. or more at 1 atmospheric pressure or a melting point of 90° C. or more at 1 atmospheric pressure) is too low to ensure stable ejection of the ink. If {(A)+(B)}/{(C)+(D)}<0.25 holds true, the printing plate has a durability problem. If {(A)+(B)}/{(C)+(D)}>0.5 holds true, the printing plate has a durability problem, and, in addition, the ejection from the ink jet head becomes unstable. Consequently, the resulting printing plate cannot form characters or images with sharp edges.

Preferably, the ink composition satisfies the following expression (4):

(C)/(D)≧5 (4)

When this expression holds true, the ink can be prevented effectively from being solidified at the nozzle faces, so that the ink can be more stably ejected.

The method of the present embodiment includes (1) preparing a printing original plate, (2) depositing an ink, and (3) heating. The operation of (1) preparing a printing original plate can be performed by a known method. However, the substrate and the hydrophilic layer of the printing original plate are selected in accordance with their compatibility with the ink.

In the operation of (1), for example, a printing original plate having a hydrophilic surface is prepared. A hydrophilic surface is one having a surface state where water-based droplets (dots) ‘can wet the surface and spread over the surface as intended when the droplets have landed on the printing original plate, and can be dried without being moved during evaporation of water. The printing original plate may be a known offset printing original plate. For forming a hydrophilic surface, the surface of the substrate may be directly subjected to, for example, anodic oxidation to impart hydrophilicity, or a hydrophilic layer may be formed on the surface of the substrate. The substrate may be made of, for example, aluminum, copper, nickel, or stainless steel. Preferably, an aluminum substrate is used. Aluminum is dimensionally stable and relatively inexpensive. For directly imparting hydrophilicity to the surface of the substrate, for example, electrochemical anodic oxidation may be applied.

For forming a hydrophilic layer on the substrate, the hydrophilic layer may be formed of, but not limited to, resins, such as polyvinyl alcohol and its derivatives, polyvinyl pyrrolidone and its derivatives, polyvinyl formal and its derivatives, polyvinyl acetate and its derivatives, polyvinyl acetal and its derivatives, and ethylene copolymers (EVOH, EVA, EAA, EMAA, EMA, EEA, etc.); or inorganic particles, such as those of silica or alumina. Among these, polyvinyl alcohol, polyvinyl pyrrolidone, silica and alumina are preferred because of their affinity for aqueous inks. More preferably, at least either polyvinyl alcohol or silica is used. These materials may be used singly or in combination.

The hydrophilic layer is formed by applying a liquid prepared by mixing any of the above hydrophilic materials and a solvent or the like together onto a substrate to form a coating, and heating the liquid coating to evaporate the solvent. Examples of the solvent include, but are not limited to, water and organic compounds (preferably water-soluble organic compounds). These solvents may be used singly or in combination. The liquid may be applied with, for example, a roll coater, a bar coater, or a gravure coater. The liquid may further contain a surfactant in addition to the hydrophilic material and the solvent. The hydrophilic layer is preferably formed to a thickness of 1 to 20 μm from the viewpoint of constantly forming a smooth, uniform hydrophilic surface.

In the operation of (2) depositing an ink, the ink is ejected onto a printing original plate from an ink jet head. The composition of the specific water-based ink will now be described.

### (A) Pigment

The pigment in the ink may be selected from inorganic pigments and organic pigments.

Inorganic pigments that can be used in the ink of the present embodiment include carbon blacks, such as furnace black, lampblack, acetylene black, and channel black (for example, C. I. Pigment Black 7). Iron oxide and titanium oxide may be used. Among these, carbon blacks are preferred for achromatic black inks. Inks containing a carbon black can be stably ejected from the ink jet head, and can form a lipophilic pattern having high visibility on a printing original plate.

Exemplary carbon blacks include, but are not limited to, Nos. 2300 and 900, MCF88, Nos. 20B, 33, 40, 45 and 52, MA7, MA8, MA100, and No. 2200B (each produced by Mitsubishi Chemical); Color Blacks FW1, FW2, FW2V, FW18, FW200, S150, S160 and S170, Pritexes 35, U, V and 140U, and Special Blacks 6, 5, 4A, 4 and 250 (each produced by Degussa AG); Conductex SC, and Ravens 1255, 5750, 5250, 5000, 3500, 1255 and 700 (each produced by Columbian Carbon); Regals 400R, 330R and 660R, Mogul L, Monarchs 700, 800, 880, 900, 1000, 1100, 1300 and 1400, and Elftex 12 (each produced by Cabot).

These carbon blacks may be used singly or in combination.

For chromatic color inks, organic pigments are used. Preferred organic pigments include, but are not limited to, quinacridone pigments, quinacridonequinone pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perinone pigments, quinophthalone pigments, anthraquinone pigments, thioindigo pigments, benzimidazolone pigments, isoindolinone pigments, azomethine pigments, and azo pigments. Among these, quinacridone pigments and phthalocyanine pigments are preferred. Inks containing these pigments can be stably ejected from the ink jet head, and can form a lipophilic pattern having high visibility on a printing original plate.

Cyan pigments that can be used in the present embodiment include, but are not limited to, C. I. Pigment Blues 1, 2, 3, 15:3, 15:4, 15:34, 16, 22 and 60, and C. I. Vat Blues 4 and 60. Preferably, one or more of C. I. Pigment Blues 15:3, 15:4 and 60 are used.

Magenta pigments that can be used in the present embodiment include, but are not limited to, C. I. Pigment Reds 5, 7, 12, 48(Ca), 48(Mn), 57(Ca), 57:1, 112, 122, 123, 168, 184 and 202, and C. I. Pigment Violet 19. Preferably, one or more of C. I. Pigment Reds 122, 202 and 209, and C. I. Pigment Violet 19 are used.

Yellow pigments that can be used in the present embodiment include, but are not limited to, C. I. Pigment Yellows 1, 2, 3, 12, 13, 14C, 16, 17, 73, 74, 75, 83, 93, 95, 97, 98, 119, 110, 114, 128, 129, 138, 150, 151, 154, 155, 180 and 185. Preferably, one or more of C. I. Pigment Yellows 74, 109, 110, 128 and 138 are used.

Orange pigments that can be used in the present embodiment include, but are not limited to, C. I. Pigment Oranges 36 and 43 and their mixtures.

Green pigments that can be used in the present embodiment include, but are not limited to, C. I. Pigment Greens 7 and 36 and their mixtures.

These pigments may be dispersed with known dispersant resins, or may be surface-oxidized or surface-sulfonated into self-dispersing pigments with ozone, hypochlorous acid, fuming sulfuric acid or the like.

The above pigments may be used singly or in combination.

### (B) Resin

The resin contained in the ink is preferably a thermoplastic resin in an emulsion form (hereinafter referred to as resin emulsion) or a water-soluble thermoplastic resin acting as a pigment dispersant (hereinafter referred to as pigment dispersant resin), from the viewpoint of dispersibility in water.

Even if the resin is insoluble in water, it is required that the resin be dispersed in water. Accordingly, the resin is preferably a polymer having both a hydrophilic portion and a hydrophobic portion, that is, a resin emulsion. If a resin emulsion is used as the thermoplastic resin, the average particle size of the resin is preferably about 150 nm or less, more preferably in the range of about 5 to 100 nm, but is not particularly limited as long as the resin can be in an emulsion form.

The average particle size mentioned herein is a value measured by dynamic light scattering using a particle size analyzer. More specifically, the average particle size mentioned herein refers to a 50% number average particle size of an emulsion diluted to 100 times with pure water measure by Nanotrac PA-EX150(manufacture by Nikkiso).

The thermoplastic resin can be selected from the thermoplastic resins conventionally used in ink jet recording inks. Examples of such a thermoplastic resin include, but are not limited to, (meth)acrylic polymers, such as poly(meth)acrylic esters and their copolymers, polyacrylonitriles and their copolymers, polycyanoacrylates, polyacrylamides, and poly(meth)acrylic acids; polyolefin polymers, such as polyethylene, polypropylene, polybutene, polyisobutylene polystyrene and their copolymers, and petroleum resins, coumarone-indene resins and terpene resins; vinyl acetate or vinyl alcohol polymers, such as polyvinyl acetates and their copolymers, polyvinyl alcohols, polyvinyl acetal, and polyvinyl ethers; halogen-containing polymers, such as polyvinyl chlorides and their copolymers, polyvinylidene chlorides, fluorocarbon polymers, and fluorocarbon rubbers; nitrogen-containing vinyl polymers, such as polyvinylcarbazole, polyvinylpyrrolidone and their copolymers, polyvinylpyridine, and polyvinyl imidazole; diene polymers, such as polybutadienes and their copolymers, polychloroprene, and polyisoprene (butyl rubber); and other ring-opening polymerization resins, condensation polymerization resins, and natural macromolecules.

Commercially available thermoplastic resins can be used. Examples of such a thermoplastic resin include Hitecs E-7025P, E-2213, E-9460, E-9015, E-4A, E-5403P and E-8237 (each produced by TOHO Chemical Industry); AQUACERs 507, 515 and 840 (each produced by BYK); and JONCRYL 680(produced by BASF).

If a thermoplastic resin is used in an emulsion state, the resin and optionally a surfactant are mixed with water. For example, a (meth)acrylic resin or styrene-(meth)acrylic resin emulsion can be prepared by mixing a (meth)acrylic ester or a styrene-(meth)acrylic ester and optionally a surfactant with water. Preferably, the mass ratio of the resin to the surfactant is about 50:1 to 5:1. If the amount of the surfactant used is less than this range, the mixture is unlikely to turn into emulsion. If the amount of the surfactant is more than this range, the water resistance of the resulting ink may be reduced or the adhesion of the ink may be degraded.

Preferred examples of the surfactant include, but are not limited to, anionic surfactants, such as sodium dodecylbenzenesulfonate, sodium lauryl sulfate, and polyoxyethylene alkyl ether ammonium sulfate; and nonionic surfactants, such as polyoxyethylene alkyl ether, polyoxyethylene alkyl ester, polyoxyethylene sorbitan fatty acid ester, polyoxyethylene alkylphenyl ether, polyoxyethylenealkylamine, and polyoxyethylenealkylamide. These surfactants may be used singly or in combination.

The thermoplastic resin emulsion may be prepared by emulsion-polymerizing a monomer of the resin in water in the presence of a polymerization catalyst and an emulsifier. The polymerization initiator, the emulsifier and the molecular weight modifier used for the emulsion polymerization are selected in accordance with a known polymerization process.

The polymerization initiator is selected from those generally used in radical polymerization. Examples of such a polymerization initiator include potassium persulfate, ammonium persulfate, hydrogen peroxide, azobisisobutyronitrile, benzoyl peroxide, dibutyl peroxide, peracetic acid, cumene hydroperoxide, t-butyl hydroxyperoxide, and p-menthane hydroxyperoxide. For a polymerization reaction in water, a water-soluble polymerization initiator is preferably used. Examples of the emulsifier include sodium lauryl sulfate and other anionic surfactants, nonionic surfactants, amphoteric surfactants, and mixtures of these surfactants. These may be used singly or in combination.

The ratio of water to the resin in the resin emulsion is preferably in the range of 60 to 400 parts by mass relative to 100 parts of resin, and more preferably in the range of 100 to 200 parts by mass.

If a resin emulsion is used as the thermoplastic resin, a known resin emulsion can be used. For example, resin emulsions disclosed in JP-B-62-1426, JP-A-3-56573, JP-A-3-79678, JP-A-3-160068 and JP-A-4-18462 may be used as they are. Commercially available resin emulsions may also be used. Examples of such a resin emulsion include Micro Gels E-1002 and E-5002 (styrene-acrylic resin emulsions, each produced by Nippon Paint), VONCOAT 4001 (acrylic resin emulsion, produced by DIC Corporation), VONCOAT 5454 (styrene-acrylic resin emulsion, produced by DIC Corporation), SAE1014 (styrene-acrylic resin emulsion, produced by Zeon Corporation), Saivinol SK-200 (acrylic resin emulsion, produced by Saiden Chemical Industry), and Polysols AP-4735, AP-3900, AT-2050 and AE820 (each produced by Showa High Polymer). Although the thermoplastic resin may be in the form of particles before being mixed with other constituents of the ink, it is preferable that the particles of the resin be dispersed in a water medium to prepare a resin emulsion, and that the resin emulsion be mixed with the other constituents of the ink. From the viewpoint of ensuring high storage stability and high ejection stability, the resin preferably has a particle size in the range of 5 to 400 nm, and more preferably in the range of 50 to 200 nm.

### (C) First Organic Compound

The ink used in the present embodiment contains a compound having a boiling point of 260° C. or more at 1 atmospheric pressure or a melting point of 90° C. or more at 1 atmospheric pressure. This organic compound is hereinafter referred to as a first organic compound. Water-soluble organic compounds may be used as the first organic compound. Examples of water-soluble organic compounds include, but are not limited to, polyhydric alcohols, such as triethylene glycol (boiling point 287° C.), tetraethylene glycol (boiling point: 314° C.), polyethylene glycol, tripropylene glycol (boiling point: 273° C.), polypropylene glycol, 1,2,6-hexanetriol (boiling point: 178° C. at 5 mmHg), thiodiglycol (boiling point: 282° C.), glycerol (boiling point: 290° C.), and trimethylolpropane (boiling point: 292° C. at 30 mmHg); and urea (melting point: 132° C.), triethanolamine (boiling point: 361° C.), and saccharides, such as trehalose (dehydrate, boiling point: 97° C.)

If polyethylene glycol or polypropylene glycol is used, the weight average molecular weight is preferably 200 to 2,000. The weight average molecular weight mentioned herein is a value measured by gel permeation chromatography (GPC). In this instance, the weight average molecular weight is obtained from a calibration curve prepared using standard samples.

The first organic compound may be a surfactant. Examples of the surfactant include, but are not limited to, silicone surfactants, acetylene glycol surfactants, and acetylene alcohol surfactants.

Exemplary silicone surfactants include polyester-modified silicones and polyether-modified silicones, and preferably polyether-modified polydimethyl siloxane or polyester-modified polydimethyl siloxane is used. Commercially available silicone surfactants may be used, such as BYK-347, BYK-348, BYK-UV 3500, BYK-UV 3510, BYK-UV 3530, and BYK-UV 3570 (each produced by BYK).

Exemplary acetylene glycol surfactants include 2,4,7,9-tetramethyl-5-decyne-4,7-diol, 3,6-dimethyl-4-octyne-3,6-diol, and 3,5-dimethyl-1-hexyne-3-ol. Commercially available acetylene glycol surfactants may be used, such as SURFYNOLs 104, 82, 465, 485, 104PG50 and TG (each available from Air Products and Chemicals), and OLFINE STG and OLFINE E1010 (each produced by Nissin Chemical Industry). The acetylene alcohol surfactant is commercially available, for example, as SURHYNOL 61 (available from Air Products and Chemicals).

The first organic compound may be an antifungal agent, a preservative, or a rust preventive agent. Examples of the antifungal agent or preservative include, but are not limited to, alkyl isothiazolones (such as methyl isothiazolone and octyl isothiazolone), chloroalkyl isothiazolone, benzoisothiazolone (such as 1,2-benzoisothiazolin-3-one), bromonitro alcohols, oxazolidine compounds, and chloroxylenol. Commercially available antifungal agent or preservative may be used, such as Proxel-XL2 (1,2-benzoisothiazolin-3-one sodium salt, produced by Arch Chemicals). Examples of the rust preventive agent include, but are not limited to, dicyclohexyl ammonium nitrite and benzotriazole.

These may be used singly or in combination.

Since the first organic compound is not volatile in a normal environment (for example, at 25° C. and 1 atmospheric pressure), it can prevent the ink from clogging the nozzles. Preferably, the first organic compound is soluble in water from the viewpoint of its use in aqueous inks. In addition, if the first organic compound is nonionic, the storage stability of the ink can be enhanced because such an organic compound does not disrupt the dispersion in the ink.

First organic compounds may be used singly or in combination.

### (D) Second Organic Compound

The ink used in the present embodiment contains an organic compound having a boiling point in the range of 100 to 250° C. at 1 atmospheric pressure. This organic compound is hereinafter referred to as a second organic compound. The second organic compound is preferably soluble in water. Examples of such an organic compound include, but are not limited to, N-methylpyrrolidone (boiling point: 202° C.), 2-pyrrolidone (boiling point: 245° C.), dimethyl sulfoxide (boiling point: 189° C.), methyl lactate (boiling point: 145° C.), ethyl lactate (boiling point: 155° C.), isopropyl lactate (boiling point: 168° C.), butyl lactate (boiling point: 188° C.), ethylene glycol monomethyl ether (boiling point: 124° C.), ethylene glycol monomethyl ether acetate (boiling point: 145° C.), diethylene glycol monomethyl ether (boiling point: 194° C.), diethylene glycol dimethyl ether (boiling point: 162° C.), diethylene glycol ethylmethyl ether (boiling point: 176° C.), diethylene glycol diethyl ether (boiling point: 189° C.), propylene glycol monomethyl ether (boiling point: 120° C.), dipropylene glycol monomethyl ether (boiling point: 188° C.), dipropylene glycol dimethyl ether (boiling point: 171° C.), 1,4-dioxane (boiling point: 101° C.), ethylene glycol (boiling point: 197° C.), diethylene glycol (boiling point: 244° C.), propylene glycol (boiling point: 188° C.), dipropylene glycol (boiling point: 232° C.), 1,3-propanediol (boiling point: 212° C.), 1,4-butanediol (boiling point: 230° C.), hexylene glycol (boiling point: 198° C.), n-butanol (boiling point: 118° C.), 1,2-hexanediol (boiling point: 224° C.), 1,2-pentanediol (boiling point: 206° C.), diethylene glycol monobutyl ether (boiling point: 116° C.), and diethylene glycol monopropyl ether (boiling point: 153° C.)

The second organic compound may be a surfactant, an antifungal agent, a preservative, or a rust preventive agent.

Second organic compounds may be used singly or in combination.

### Water

Preferably, the water in the ink used in the present embodiment is pure water or ultrapure water, such as ion exchanged water, ultrafiltered water, reverse osmotic water, or distilled water. More preferably, the water is sterilized, for example, by irradiation with UV light or by adding hydrogen peroxide. Such water prevents occurrence of mold and bacteria over the long term.

In addition to the above constituents, the ink used in the present embodiment may contain other additives.

### Other Constituents

Other constituents (additives) include, but are not limited to, an antioxidant, a thickener, a saccharide, a pH adjuster, and a surface conditioner.

In the present embodiment, the above-described specific ink is ejected onto a printing original plate from an ink jet head of an ink jet printing system to make an offset printing plate having high definition (high resolution) and high durability. The method of the present embodiment can provide an offset printing plate with high cost efficiency and environmental advantages.

Preferably, the method of the present embodiment further includes (3) heating the printing original plate on which the ink has been deposited, from the viewpoint of enhancing the fixability of the ink to the printing original plate. In this instance, the heating temperature is preferably 40 to 150° C. from the viewpoint of achieving a high fixability to the printing original plate.

Thus, the method of the present embodiment allows the ink to be ejected stably, and, accordingly, can make a highly durable printing plate capable of high-resolution printing. More specifically, the ink used in the present embodiment can be ejected stably by an ink jet method, and the printing plate made by the method of the present embodiment can ensure high-resolution offset printing at 150 LPI or more, and exhibits such a high durability that can continuously print about 3,000 copies.

The printing plate made by the method of the present embodiment has the same structure as known printing plates except that it is made as described above. The offset printing apparatus used in the present embodiment has the same structure as known offset printing apparatuses except that it has the printing plate made by the method of the present embodiment. The printing plate made by the method of the present embodiment and the offset printing apparatus having the printing plate can ensure high-resolution offset printing at 150 LPI or more, and exhibits such a high durability that can continuously print about 3,000 copies.

### EXAMPLES

The embodiment of the invention will now be further described in detail with reference to Examples, and the invention is not limited to those Examples.

### Preparation of Printing Original Plate

### Printing Original Plate 1

A liquid prepared by mixing the following constituents was applied onto the surface of an aluminum substrate (thickness: 100 μm) subjected to anode oxidation (electrolyte: dilute sulfuric acid, temperature: 20° C., voltage: 15 V, time: 20 minutes) with a roll coater, followed by drying in a warm air heating furnace of 120° C. Thus, a 5 μm thick smooth hydrophilic layer was formed over the surface of the aluminum substrate to yield printing original plate 1.
JP-20 (polyvinyl alcohol, saponification degree: about 88 mol %, produced by JAPAN VAM & POVAL): 10% by mass
AD-2 (ethylene-vinyl acetate copolymer, non-volatile component: 55%, produced by Showa High Polymer): 30% by mass
BYK-349 (silicone surfactant, produced by BYK): 1% by mass
Ethylene glycol: 30% by mass
Pure water: balance

### Printing Original Plate 2

A liquid prepared by mixing the following constituents was applied onto the surface of an aluminum substrate (thickness: 100 μm) subjected to anode oxidation with a roll coater under the same conditions as printing original plate 1, followed by drying in a warm air heating furnace of 120° C. Thus, a 5 μm thick smooth hydrophilic layer was formed over the surface of the aluminum substrate to yield printing original plate 2.
SNOWTEX C (silica particles, active component: 20%, produced by Nissan Chemical Industries): 30% by mass
Polyvinyl pyrrolidone K-85 (polyvinyl pyrrolidone, produced by Nippon Shokubai): 10% by mass
Polysol AP5051 (styrene-acrylic resin emulsion, non-volatile component: 50%, produced by Showa High Polymer): 30% by mass
Pure water: balance

### Printing Original Plate 3

A 120 μm thick aluminum substrate was subjected to anode oxidation (temperature: 20° C., voltage: 15 V, time: 60 minutes) using dilute sulfuric acid as electrolyte to impart hydrophilicity to the surface of the substrate. This substrate having a hydrophilic surface was used as printing original plate 3.

### Preparation of Water-Based Ink

### Ink 1

A stock mixture was prepared by mixing 2.5 parts by mass of 1,2-hexanediol, 7 parts by mass of glycerol, 0.8 parts by mass of BYK-348 (silicone surfactant, produced by BYK), and 30 parts by mass of ion exchanged water, and stirring the constituents at room temperature for 20 minutes. Then, 1.6 parts by mass of JONCRYL 680 (styrene-acrylic resin, molecular weight: 4,900, acid value: 215, produced by BASF) was added as a pigment dispersant resin to the stock mixture, and the liquid was stirred at 40° C. for 1 hour to yield liquid mixture I.

To the resulting liquid mixture I was added 5 parts by mass of magenta pigment (mixture of C. I. Pigment Red 202 and C. I. Pigment Violet 19, produced by BASF) to yield liquid mixture II. Liquid mixture II was agitated to be dispersed in a table sand mill (manufacture by Hayashi Shoten) with zirconia beads (diameter: 1.5 mm) in an amount of 1.5 times the mass of liquid mixture II at 2,160 rpm for 2 hours. After being dispersed, the liquid was filtered through a 0.1 mm SUS mesh filter to yield dispersion liquid I.

To the resulting dispersion liquid I were added 1,2-hexanediol, glycerol, trehalose (produced by Hayashibara), Proxel-XL2 (preservative, produced by Arch Chemicals), and ion exchanged water according to the amounts (parts by mass) shown in Table 1, and the mixture was stirred at 40° C. for 20 minutes to yield dispersion liquid II. After being stirred, dispersion liquid II was filtered through a 5 μm membrane filter to yield Ink 1 shown in Table 1.

### Ink 2

Ink 2 having the composition shown in Table 1 was prepared in the same manner as in the preparation of Ink 1. However, in this instance, the amount of pigment dispersant resin added was 1.2 parts by mass, and 5 parts by mass of yellow pigment (C. I. Pigment Yellow 74, produced by Dainichiseika Color & Chemicals Mfg) was added to liquid mixture I for preparing dispersion liquid I, instead of 5 parts by mass of the magenta pigment. Also, 1,2-hexanediol, glycerol, trehalose, Proxel-XL2, and ion exchanged water were added to dispersion liquid I, according to the amounts (parts by mass) shown in Table 1, and the mixture was stirred at 40° C. for 20 minutes to yield dispersion liquid II.

### Ink 3

Ink 3 having the composition shown in Table 1 was prepared in the same manner as in the preparation of Ink 1. However, in this instance, 4 parts by mass of cyan pigment (C. I. Pigment Blue 15:3, produced by DIC) was added to liquid mixture I for preparing dispersion liquid I, instead of 5 parts by mass of magenta pigment. Also, 1,2-hexanediol, glycerol, Polysol AP-4735 (acrylic resin emulsion, active component: 50%, produced by Showa High polymer), Proxel-XL2, and ion exchanged water were added to dispersion liquid I, according to the amounts (parts by mass) shown in Table 1, and the mixture was stirred at 40° C. for 20 minutes to yield dispersion liquid II.

### Ink 4

Ink 4 having the composition shown in Table 1 was prepared in the same manner as in the preparation of Ink 1. However, in this instance, the amount of pigment dispersant resin added was 1.4 parts by mass, and 3 parts by mass of orange pigment (C. I. Pigment Orange 43, produced by Dainichiseika Color & Chemicals Mfg) was added to liquid mixture I for preparing dispersion liquid I, instead of 5 parts by mass of magenta pigment. Also, 1,2-hexanediol, glycerol, Polysol AP-3900 (acrylic-silicone resin emulsion, active component: 50%, produced by Showa High polymer), Proxel-XL2, and ion exchanged water were added to dispersion liquid I, according to the amounts (parts by mass) shown in Table 1, and the mixture was stirred at 40° C. for 20 minutes to yield dispersion liquid II.

### Ink 5

Ink 5 having the composition shown in Table 1 was prepared in the same manner as in the preparation of Ink 1. However, in this instance, the amount of pigment dispersant resin added was 1.7 parts by mass, and C. I. Pigment Violet 19 (produced by BASF) was added as the magenta pigment to liquid mixture I for preparing dispersion liquid I. Also, 1,2-hexanediol, glycerol, Polysol AT-2050 (styrene-acrylic resin emulsion, active component: 40%, produced by Showa High polymer), Proxel-XL2, and ion exchanged water were added to dispersion liquid I, according to the amounts shown in Table 1, and the mixture was stirred at 40° C. for 20 minutes to yield dispersion liquid II.

### Ink 6

Ink 6 having the composition shown in Table 1 was prepared in the same manner as in the preparation of Ink 1. However, in this instance, the amount of pigment dispersant resin added was 1.7 parts by mass, and 2 parts by mass of carbon black (produced by Mitsubishi Chemical) was added to liquid mixture I for preparing dispersion liquid I, instead of 5 parts by mass of magenta pigment. Also, 1,2-hexanediol, glycerol, trehalose, Polysol AE820 (styrene-acrylic resin emulsion, active component: 45%, produced by Showa High polymer), Proxel-XL2, and ion exchanged water were added to dispersion liquid I, according to the amounts shown in Table 1, and the mixture was stirred at 40° C. for 20 minutes to yield dispersion liquid II.

### Ink 7

Ink 7 having the composition shown in Table 1 was prepared in the same manner as in the preparation of Ink 1, except that 1,2-hexanediol, glycerol, trehalose, AE140 (carboxy-modified acrylic resin emulsion, active component: 35%, produced by E-TEC), Proxel-XL2, and ion exchanged water were added to dispersion liquid I prepared in the preparation of Ink 1 according to the amounts shown in Table 1, and the mixture was stirred at 40° C. for 20 minutes to yield dispersion liquid II.

### Ink 8

The amount of glycerol used for preparing the stock mixture was changed to 2 parts by mass, and 1.6 parts by mass of JONCRYL 586 (styrene-acrylic resin, molecular weight: 4,600, acid value: 108, prepared by BASF) was added as the pigment dispersion resin for preparing the liquid mixture. Then, Ink 8 having the composition shown in Table 1 was prepared in the same manner as in the preparation of Ink 1. However, in this instance, 4 parts by mass of cyan pigment (C. I. Pigment Blue 15:3, produced by DIC) was added to liquid mixture I for preparing dispersion liquid I, instead of 5 parts by mass of magenta pigment. Also, 1,2-hexanediol, Proxel-XL2, and ion exchanged water were added to dispersion liquid I, according to the amounts (parts by mass) shown in Table 1, and the mixture was stirred at 40° C. for 20 minutes to yield dispersion liquid II.

### Ink 9

For preparing a stock mixture, 2 parts by mass of 2-pyrrolidone and 5 parts by mass of glycerol were used instead of 7 parts by mass of glycerol. Also, 1.5 parts by mass of JONCRYL 611 (styrene-acrylic resin, molecular weight: 8,100, acid value: 53, prepared by BASF) was added as the pigment dispersion resin for preparing liquid mixture I. Then, Ink 9 having the composition shown in Table 1 was prepared in the same manner as in the preparation of Ink 1. However, in this instance, 5 parts by mass of yellow pigment (C. I. No. P. Y. 180, produced by Dainichiseika Color & Chemicals Mfg) was added to liquid mixture I for preparing dispersion liquid I, instead of 5 parts by mass of magenta pigment. Also, triethylene glycol, Vinyblan 2586 (styrene-acrylic resin emulsion, active component: 45%, produced by Nisshin Chemical Industry), Surfinol 465 (acetylene glycol surfactant, produced by Nisshin Chemical Industry), Proxel-XL2, and ion exchanged water were added to dispersion liquid I, according to the amounts (parts by mass) shown in Table 1, and the mixture was stirred at 40° C. for 20 minutes to yield dispersion liquid II.

### Ink 10

For preparing a stock mixture, 2 parts by mass of 2-pyrrolidone and 9 parts by mass of glycerol were used instead of 7 parts by mass of glycerol, and 1 part by mass of Surfinol 465 was used instead of 0.8 parts by mass of BYK-348 (silicone surfactant, produced by BYK). Also, 1.5 parts by mass of JONCRYL 690 (styrene-acrylic resin, molecular weight: 16,500, acid value: 240, prepared by BASF) was added as the pigment dispersion resin for preparing liquid mixture I. Then, Ink 10 having the composition shown in Table 1 was prepared in the same manner as in the preparation of Ink 1. However, in this instance, 0.5 parts by mass of carbon black (MA-100, produced by Mitsubishi Chemical) was added to liquid mixture I for preparing dispersion liquid I, instead of 5 parts by mass of magenta pigment. Also, Vinyblan 2580 (acrylic resin emulsion, active component: 45%, produced by Nisshin Chemical Industry), Proxel-XL2, and ion exchanged water were added to dispersion liquid I, according to the amounts (parts by mass) shown in Table 1, and the mixture was stirred at 40° C. for 20 minutes to yield dispersion liquid II.

TABLE 1

| | | (B) | (B) | (D) | | | | (C) | (C) | (C) | (C) | |
|---|---|---|---|---|---|---|---|---|---|---|---|---|
| | (A) | Dispersant | Resin | 1,2-Hexane | (D) | (C) | (C) | Triethylene | BYK- | Surfinol | Proxel- | Pure |
| | Pigment | resin | emulsion | diol | 2-Pyrrolidone | Glycerol | Trehalose | glycol | 348 | 465 | XL2 | water |
| Ink 1 | 5 | 1.6 | — | 2.5 | — | 7 | 4.5 | — | 0.8 | — | 0.2 | 78.4 |
| Ink 2 | 5 | 1.2 | — | 7 | — | 13 | 4 | — | 0.8 | — | 0.2 | 68.8 |
| Ink 3 | 4 | 1.6 | 0.6 | 4 | — | 7.5 | — | — | 0.8 | — | 0.2 | 81.3 |
| Ink 4 | 3 | 1.4 | 0.2 | 4.5 | — | 18 | — | — | 0.8 | — | 0.2 | 71.9 |
| Ink 5 | 5 | 1.7 | 0.6 | 4 | — | 7 | — | — | 0.8 | — | 0.2 | 80.7 |
| Ink 6 | 2 | 1.7 | 0.6 | 5 | — | 17 | 7 | — | 0.8 | — | 0.2 | 65.7 |
| Ink 7 | 5 | 1.6 | 0.9 | 2.5 | — | 20 | 4 | — | 0.8 | — | 0.2 | 65 |
| Ink 8 | 4 | 1.6 | — | 8.5 | — | 2 | — | — | 0.8 | — | 0.2 | 82.9 |
| Ink 9 | 5 | 1.5 | 0.5 | — | 2 | 5 | — | 15 | 0.8 | 1 | 0.2 | 69 |
| Ink 10 | 0.5 | 0.5 | 2 | — | 2 | 9 | — | — | — | 1 | 0.2 | 84.8 |

The contents of the constituents in each of Inks 1 to 10 are shown in Table 2.

TABLE 2

| | | | | {(A) + (B)}/ | |
|---|---|---|---|---|---|
| | (C) | (A) + (B) | (C) + (D) | {(C) + (D)} | (C)/(D) |
| Ink 1 | 12.5 | 6.6 | 15.0 | 0.44 | 5.0 |
| Ink 2 | 18.0 | 6.2 | 25.0 | 0.25 | 2.6 |
| Ink 3 | 8.5 | 6.2 | 12.5 | 0.50 | 2.1 |
| Ink 4 | 19.0 | 4.6 | 23.5 | 0.20 | 4.2 |
| Ink 5 | 8.0 | 7.3 | 12.0 | 0.61 | 2.0 |
| Ink 6 | 25.0 | 4.3 | 30.0 | 0.14 | 5.0 |
| Ink 7 | 25.0 | 7.5 | 27.5 | 0.27 | 10.0 |
| Ink 8 | 3.0 | 5.6 | 11.5 | 0.49 | 0.4 |
| Ink 9 | 22.0 | 7.0 | 24.0 | 0.29 | 11.0 |
| Ink 10 | 10.2 | 3.0 | 12.2 | 0.25 | 5.1 |

Preparation of Ejection of Ink from Ink Jet Head

An experiment was performed to make printing plates, using PX-7550 (ink jet printer, manufactured by Seiko Epson). This experiment does not limit the invention.

Matte black ink cartridges were charged with Inks 1 to 10, respectively, and mounted to the printer. Thus, the ink jet head was charged with each ink. Then, it was confirmed that the inks were ejected from the head.

### Evaluation of Ejection Stability

For making a printing plate, inks were continuously ejected from the ink jet head at 25° C. and 40% RH. The ejection (solid printing) was performed at a driving frequency of 50 kHz, a resolution of 1440 dpi×1440 dpi, and a duty of 100%. The term “duty” mentioned herein is calculated from the following equation:

Duty (%)=number of recorded dots in practice/(vertical resolution×horizontal resolution)×100

(In the equation, the “number of recorded dots in practice” refers to the number of dots actually recorded per unit area, and the “vertical resolution” and the “horizontal resolution” each refer to a resolution per unit area.)

At this time, the ejection stability was evaluated. The evaluation criteria were as follows:
Good: Dot missing or deviation of ejected ink droplets did not occur during ejection for 1 hour.
Fair to Good: Dot missing or deviation of ejected ink droplets occurred during ejection for 1 hour, but such a defect was repaired by cleaning.
Fair: Dot missing or deviation of ejected ink droplets occurred within 30 minutes, but such a defect was repaired by cleaning.
Bad: Dot missing or deviation of ejected ink droplets occurred within 30 minutes, and such a defect could not be repaired even by cleaning.

### Printing Plate Making

Patterns of characters and images were printed on printing original plates 1 to 3 of 318 mm by 469 mm in size at a resolution of 2,880 dpi×1,440 dpi with a printing software program by ejecting ink droplets from a head whose piezoelectric element was altered so that the amount of ejected ink droplets could be adjusted in the range of 5 to 15 ng as needed. After printing, the patterns were heated at 120° C. for 10 minutes in the atmosphere, and thus printing plates were made. For forming the pattern, 5-points double-type Japanese hiragana characters (font: MS Ming-cho type) were used.

Offset printing was performed using the resulting printing plates for evaluation. More specifically, the printing plate was set to ROLAND 50 (sheet-fed offset printer, manufactured by Manroland), and printing was performed on OK Top Coat+(basis weight: 84.9 g/m^{2,} size: 636 mm×939 mm).

### Evaluation of Printing Resolution

Since the character pattern requires the highest resolution of the patterns of a printing plate, the criteria for the evaluation were set as below.
Good: Even characters of 5 points or less were legible.
Bad: Characters of 5 points or less were illegible.

### Evaluation of Durability

Since the character pattern is required to be most durable of the patterns of a printing plate, the criteria for the evaluation were set as below.
Good: Even characters of 5 points or less could be clearly printed on 2,000 copies or more.
Bad: Prints on which characters of 5 points or less had been clearly printed were less than 2,000 copies.

The evaluation results are shown in Table 3.

TABLE 3

| | Printing | | | | |
|---|---|---|---|---|---|
| | original plate | Ejection | Printing | Plate | |
| | number | stability | Resolution | durability | notes |
| Ink 1 | 1 | Good | Good | Good | — |
| Ink 2 | 2 | Fair to | Good | Good | — |
| | | Good | | | |
| Ink 3 | 3 | Fair | Good | Good | — |
| Ink 4 | 1 | Good | Good | Bad | — |
| Ink 5 | 1 | Fair | Bad | — | — |
| Ink 6 | 1 | Good | — | — | Not fixed by |
| | | | | | heating |
| Ink 7 | 1 | Good | — | — | Not fixed by |
| | | | | | heating |
| Ink 8 | 1 | Bad | — | — | Ejection failure |
| Ink 9 | 1 | Good | Good | Good | — |
| Ink 10 | 1 | Good | Good | Good | — |

Table 3 shows that Inks 1 to 3 and 9 and 10, which correspond to the examples of the invention, can make more durable printing plates with higher ejection stability than Inks 4 to 8, which correspond to comparative examples.

“Not fixed by heating” shown in Inks 7 and 8 means that they could not make printing plates.

What is claimed is:

1. A method for making a printing plate comprising:
ejecting an ink onto a printing original plate from an ink jet head, the ink containing water, a pigment, a resin, a first organic compound having a boiling point of 260° C. or more at 1 atmospheric pressure or a melting point of 90° C. or more at 1 atmospheric pressure, and a second organic compound having a boiling point in the range of 100 to 250° C. at 1 atmospheric pressure, the ink satisfying expressions (1) to (3):
5% by mass<(C)<25% by mass (1);
{(C)+(D)}≧12% by mass (2); and
0.25≦{(A)+(B)}/{(C)+(D)}≦0.5 (3),
wherein (A), (B), (C) and (D) represent the pigment content, the resin content, the first organic compound content, and the second organic compound content in the ink, respectively.

2. The method according to claim 1, wherein the ink satisfies the expression:
{(C)/(D)}≧5 (4)

3. The method according to claim 1, further comprising heating the printing original plate on which the ink has been deposited.
